(19) United States
(12) Patent Application Publication
(10) Pub. No.: US 2026/0299979 A1
(43) Pub. Date: Oct. 1, 2026

(54) ADVANCED INPUT DEVICE SHORTCUTS

(71) Applicant: Lenovo Global Technology (United States) Inc., Morrisville, NC (US)

(72) Inventors: Nathan Peterson, Morrisville, NC (US); Mark Delaney, Morrisville, NC (US); John C Mese, Morrisville, NC (US)

(21) Appl. No.: 19/093,665

(22) Filed: Mar. 28, 2025

(51) Int. Cl. G06F 9/451; G06F 3/0354

(52) U.S. Cl. CPC G06F 9/453; G06F 3/03543

(57) ABSTRACT

In one aspect, an apparatus includes a processor system and storage accessible to the processor system. The storage includes instructions executable by the processor system to identify a sequence of actions at a first device that are performed using an input device. The instructions are also executable to identify an input device shortcut, as implemented at a second device different from the first device, that correlates to the sequence of actions at the first device. The instructions are then executable to, based on the identification of the input device shortcut, present a notification at the first device regarding implementation of the input device shortcut at the first device. The shortcut might be a macro or hotkey. Additionally, the shortcut may be identified using crowdsourced data from users within the same organization as the user of the first device.

### FIELD

The disclosure below relates to technically inventive, non-routine solutions that are necessarily rooted in computer technology and that produce concrete technical improvements. In particular, the disclosure below relates to advanced input device shortcuts.

### BACKGROUND

As recognized herein, the increasing sophistication of modern, advanced input devices presents opportunity for additional software advances. The disclosure below therefore recognizes that additional advances can be realized to further optimize these input devices.

### SUMMARY

Accordingly, in one aspect an apparatus includes a processor system and storage accessible to the processor system. The storage includes instructions executable by the processor system to identify a sequence of actions at a first device that are performed using an input device. The instructions are also executable to identify an input device shortcut, as implemented at a second device different from the first device, that correlates to the sequence of actions at the first device. The identified input device shortcut is not already implemented at the first device. The instructions are then executable to, based on the identification of the input device shortcut, present a notification at the first device regarding implementation of the input device shortcut at the first device.

In one non-limiting example, the input device shortcut may include a mouse shortcut. The mouse shortcut may apply a macro or hotkey for a button selection on the mouse.

Additionally, in some example embodiments the instructions may be executable to determine that the sequence of actions has been performed at the first device at least a threshold number of times greater than one. Here, the instructions may then be executable to, based on the sequence of actions being performed at the first device at least the threshold number of times greater than one, present the notification at the first device.

Also in certain example embodiments, the instructions may be executable to, based on the identification of the input device shortcut, present a selector on a display of the first device. The selector may be selectable to set a first application (“app”) to issue commands consistent with the input device shortcut responsive to manipulations of a particular input element on the input device. In some instances, the first app may be an input device app that is executable to interface between the input device and other apps executable at the first device. Additionally or alternatively, the first app may be an operating system of the first device. In terms of the particular input element itself, in non-limiting instances it may include one or more of a button, a touch sensor, a pressure sensor, a wheel, and/or a track ball.

If desired, in some example embodiments the instructions may also be executable to identify the input device shortcut using analytics of data associated with an organization with which a first user of the first device and a second user of the second device are associated. So, for example, the data may be crowdsourced data for the organization.

In various example implementations, the apparatus may include some or all of the first device, the input device, and/or a server that communicates with the first device to present the notification.

In another aspect, a method includes identifying a sequence of actions at a first device that are performed using an input device. The method also includes identifying a shortcut, as implemented at a second device different from the first device, that correlates to the sequence of actions at the first device. The identified shortcut is not already implemented at the first device. Based on the identification of the shortcut, the method includes presenting an option at the first device to implement the shortcut at the first device.

In certain example implementations, the option may be presented with a notification identifying the shortcut and indicating that the shortcut can be implemented at the first device. If desired, the notification may also indicate an average amount of time that a user of the first device can save by using the shortcut. The average amount of time that the user can save may be based on an average amount of time taken by the user to perform the sequence of actions at the first device without the shortcut.

In still another aspect, an apparatus includes at least one computer readable storage medium (CRSM) that is not a transitory signal. The at least one CRSM includes instructions executable by a processor system to identify sequence of inputs at a first device that are performed using an input device. The instructions are also executable to identify a shortcut, as implemented at other devices within a same organization as a user of the first device, that correlates to the sequence of inputs at the first device. The shortcut is not already implemented at the first device. The instructions then also executable to, based on the identification of the shortcut, present an option at the first device to implement the shortcut at the first device.

If desired, in some non-limiting example embodiments the instructions may be executable to use an active directory to identify the shortcut as implemented at the other devices within the same organization.

### BRIEF DESCRIPTION OF THE DRAWINGS

The details of present principles, both as to their structure and operation, can best be understood in reference to the accompanying drawings, in which like reference numerals refer to like parts, and in which:

FIG. 1 is a block diagram of an example system consistent with present principles;

FIG. 2 is a block diagram of an example network of devices consistent with present principles;

FIG. 3 shows a perspective view of an example advanced input device that may be used consistent with present principles;

FIG. 4 shows an example shortcut recommendation that may be presented to a user consistent with present principles;

FIG. 5 illustrates example logic in flow chart format that may be executed by an apparatus consistent with present principles; and

FIG. 6 shows an example settings graphical user interface (GUI) that may be presented for a user to configure one or more settings of a client device or app to operate consistent with present principles.

### DETAILED DESCRIPTION

Among other things, the detailed description below discusses smart mouse buttons and macros, where the system can determine the most common macros for the buttons on the mouse using data from within the user's company, department, or other organization. The system can then make suggestions to the users within the organization about what others are doing in terms of macros.

A software application associated with the mouse might therefore analyze things that a given user does and that others have set as macros to then tell the user the average amount of time that could be saved by using the macro. The amount of time saved may be determined as the difference between the average amount of time it currently takes the user to do the task without the macro and the average amount of time it takes the user's co-workers to do the same task with the macro(s) being implemented.

Additionally, note that present principles may apply not just to macros but also to hotkeys and still other types of input device shortcuts. In terms of hotkeys, in particular non-limiting example embodiments, hotkeys may be a single user input or multiple user inputs (e.g., button selections) that trigger a specific action like launching an application (“app”) or performing a cut, copy, or paste command. Also in certain non-limiting example embodiments, a macro may be established as a recorded sequence of keystrokes, mouse clicks, and/or other commands that can be strung together and autonomously executed by the client device to perform a complex task (e.g., one involving multiple steps).

Thus, devices and methods discussed below provide techniques for generating recommended hotkeys, macros, and other features based on analytics across an organization. If desired, present principles may even be applied as a desktop-as-service offering.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single-or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C#or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

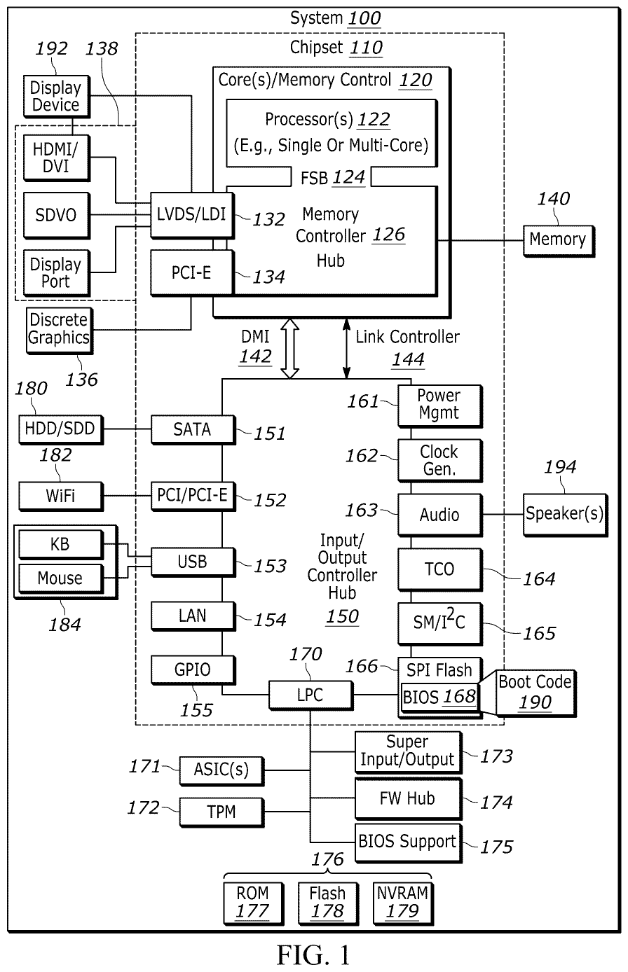

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Attention-based and/or transformer-based architectures may be used. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

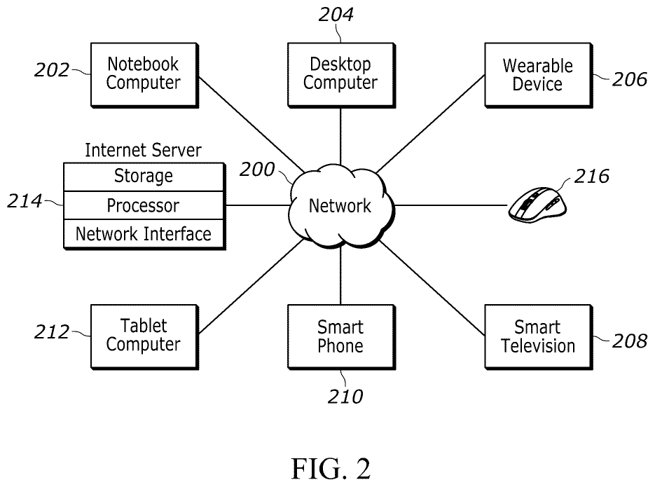

Turning now to FIG. 2, example devices are shown communicating over a network 200 such as the Internet consistent with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and an input device 216. Note that although the input device 216 is represented as a computer mouse, it might also be a wired or wireless keyboard, a laptop track pad, a trackball device, a joystick device, and/or an electronic stylus. Still other types of input devices are also encompassed by present principles. But regardless of input device type, note that each input device may still include one or more hard or soft buttons, and/or or other input elements, to implement a macro or hotkey that is being recommended by the system consistent with the disclosure below.

FIG. 2 also shows that a server 214 may be connected to the network 200. The server 214 may be a cloud-based Internet server providing cloud storage accessible to the devices 202-212, 216. Additionally, the server 214 may host an enterprise-level active directory for different client devices that are securely connected to it over the network 200. The client devices in the active directory may therefore be the client devices of different people within the same organization, such as the same business, government agency, volunteer organization, social club, etc. All those client devices may thus be configured to communicate with the server 214 over the network 200 to undertake present principles.

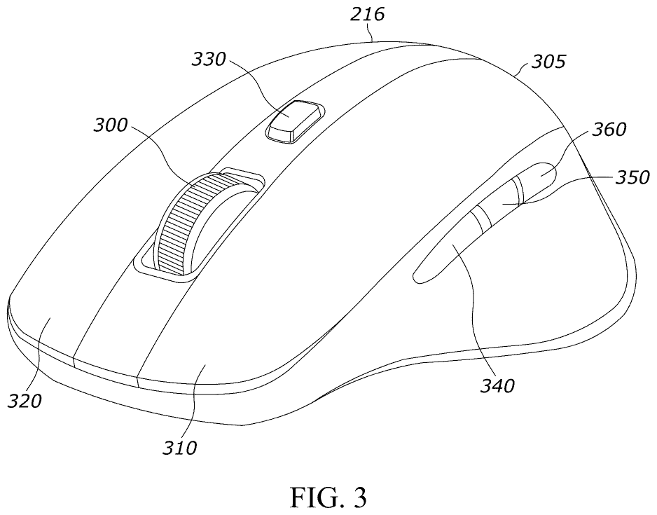

Now in reference to FIG. 3, this figure shows a front perspective view of the input device 216. As shown, the device 216 may include a rigid housing 305, such as one made of a plastic and/or polymer. Additionally, note that the input device 216 in the present example is embodied as a computer mouse, which may be moved across a surface to control a cursor presented on a display of the end-user's client device. The optical sensor that is used for monitoring this X-Y movement may be located on the bottom of the input device 216 and is therefore not shown in the front perspective view of FIG. 3.

The input device 216 may also include one or more other input elements besides the optical sensor, such as a scroll wheel 300, a left-click button 310, a right-click button 320, and a top utility button 330. The input device 216 may include still other buttons on the left and right sides of its housing 305. As such, the input device 216 may include three buttons 340, 350, and 360 on the left side of the input device's housing 305. Though not shown, the input device 216 may include still other input elements on other portions of the housing 205, including but not limited to touch sensors, pressure sensors, and/or track balls on other portions of the housing 305.

It is to be further understood that any of the aforementioned input elements may be used in combination with each other and with input elements on still other input devices (e.g., keys on a wireless keyboard) for a user to provide a repeated sequence of inputs to a client device connected over Bluetooth or other connection to the input device(s).

Suppose therefore that the user is identified by the system as providing the same sequence of inputs to his or her client device to perform a routine or repetitive task for his/her job within an organization. Consistent with present principles, the data of the organization may then be parsed and analyzed using analytics and artificial intelligence (AI) for the system to recommend a shortcut to the user to continue executing the same task but with the shortcut. The shortcut may be one identified as being performed by other members of the same organization, possibly as assigned to the same job or task as the user, and hence may be correlated by the system to the same repeated sequence of inputs that is already being provided by the user themselves. The system may thus recommend a relevant shortcut to the user to optimize operations at the user's own client device.

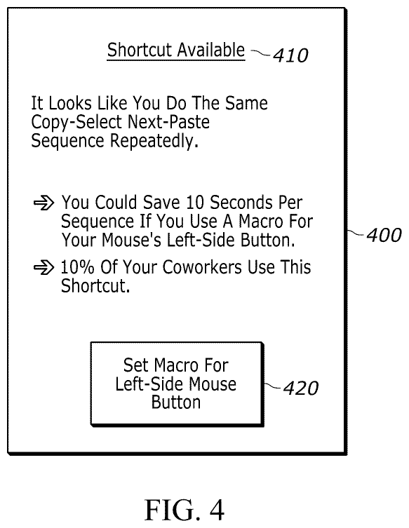

With the foregoing in mind, reference is now made to FIG. 4. This figure shows an example graphical user interface (GUI) 400 that may be presented on a display of the user's client device (e.g., referred to as a “first device” in the description below) responsive to identifying a shortcut from crowdsourced data of other users within the same organization. As shown, the GUI 400 may include a notification 410 that a shortcut is available for implementation at the user's input device, with the notification 410 indicating that the system has identified the user as performing the same three-input sequence of copy-select next cell-paste for repeated spreadsheet data entry. As such, in the present instance the following text may be presented as part of the notification 410:“Shortcut Available: It looks like you do the same copy-select next-paste sequence repeatedly.”

It may also be appreciated from FIG. 4 that the notification 410 may identify the shortcut itself (a “macro” to execute the same input sequence per this example) and indicate that the shortcut can be implemented at the first device using a given input element on the user's input device. The notification 410 might also indicate an average amount of time that the user of the first device might save by using the recommended shortcut. As such, the notification 410 may include the following text per this example: “You could save 10 seconds per sequence if you use a macro for your mouse's left-side button.”

Note that this average amount of time that the user is estimated to save may be based on the difference between the average amount of time taken by the user in the past to perform the sequence of actions without using the shortcut and the average amount of time it takes other users within the same organization to perform the same overall task or function using the recommended shortcut. If desired, the notification 410 may include still other statistics for the user to observe, including that “10% of your coworkers use this shortcut.”

The GUI 400 may also include a selector 420 or other option that is selectable to provide input to the first device to implement the relevant macro (or hotkey) for the associated task being accomplished through the user's sequence of more-voluminous individual inputs. The selector 420 may therefore be selectable to set a first app executable at the first device to issue commands consistent with the recommended shortcut responsive to manipulations of the associated input element on the input device (the left-side button of the user's mouse in this case).

In certain non-limiting examples, the first app may be an input device app that is executable to interface between the input device itself and other apps executing at the first device, whether those other app(s) are the operating system(s) of the first device or individual software apps. For instance, the input device app may be firmware or software from a manufacturer of the input device that gets installed on the first device for the first device to then receive and translate input from the input device itself.

Or as another example, the first app may be an operating system of the first device itself, such as a guest operating system (e.g., Windows or MacOS) or native operating system (e.g., BIOS). So here, the first device might set an operating system setting to implement the macro for the assigned mouse button.

Also note consistent with present principles that the first device may scrape or otherwise identify data related to an individual software app or file type with which the user is currently interacting through the first device's active (operative) window as presented in the first device's foreground display. This may be done for the device to first identify the app or file type to which the repetitive sequence of inputs is being directed and to then, in non-limiting examples, only implement and execute the recommended macro while the first device is again operating in that same context (e.g., executing and presenting the same software app, and/or presenting a file of the same file type). The same input device element may then be repurposed for other functions, and even for other macros or hotkeys, for different app contexts and/or file type contexts that subsequently become operative.

With this recognition in mind (that the same mouse button or other input element may have different recommended and assigned macros based on different device contexts), it is to be further understood that such app-specific and file type-specific macro implementations may occur whether the active window shows content sourced from the user's local client (first) device or from a remote client device (or remote server) that is being remotely accessed by the first device through a remote desktop protocol (RDP) session.

Accordingly, in one specific example, the system may use additional data from web browsers and remote desktop applications being executed at the first device to determine a proper mouse/keyboard profile (macro/hotkey-context combination) to utilize. The mouse's software app may therefore have knowledge not only of the other app that is currently being presented at the client device itself (e.g., a web browser), but also the type of content or specific type of file (or app) being presented at the remote client through the web browser or remote desktop app. The type of content or file might be a spreadsheet, a word processing document, a slide presentation file, etc. With this knowledge, the mouse's app may then implement a macro assigned to the current context of the remote client rather than the local client device itself (e.g., according to the macro's profile). In the present instance, a spreadsheet-associated macro may therefore be executed responsive to a left-side button selection from the mouse while a spreadsheet file is currently presented at the remote client (e.g., rather than the local device implementing a different macro for a web browser that is currently presented locally to remote into the remote client). But it is reiterated that the same mouse button may still be selected to execute a different macro when a different local or remote context is occurring.

In terms of identifying the content or file type itself, the following non-exhaustive techniques may be used. As one example, screen scraping and content recognition software may be used.

As another example, the website or app presenting the foreground window may identify the content or file type in metadata sent to the client device itself for the client device to therefore identify the content/type through the metadata. In one specific instance, the mouse app might know that the user is using an online spreadsheet document through a web browser and, as such, may implement a macro or hotkey specific to the context of the online spreadsheet file type and/or specific website being used rather than to the particular app itself (e.g., the web browser).

Also in one specific instance, the first device may even correlate file types or content types between different apps to apply the same macro from one app context to another app context. E.g., the first device may identify that the spreadsheet file type as presented through the first device's web browser is the same (or similar to) the file type used by a separate spreadsheet app that is also stored at and executable by the first device. So here, the same macro or hotkey may be implemented for the browser as was already implemented for the spreadsheet app to execute an associated input sequence.

Providing another example specifically in the context of an RDP session, the remote device may pass its remote focus information (metadata about the active window at the remote device) through the secure RDP session to the (local) first device for the first device to then implement the associated macro. This might include an operative window identifier like “Remote Focus” or “Remote Web Browser.” Or the remote device (or first client device itself) may mask the RDP application being executed locally at the first device and instead represent to the first device's local focus (execution environment) whatever app, file type, or content is active at the remote system so that the new identifier is more compatible with existing macro applications given whatever the user is actually trying to accomplish.

Additionally, in some instances local apps that have a relatively significant dependence on the currently-focused application could also check to see if there is a Remote Focus application designated through the RDP session. So, if the user has a copy/paste macro defined for a button on the user's mouse for data manipulations within a spreadsheet app, the first device may send those commands from the first device through the RDP session to the remote device to execute the macro at the remote device itself while it presents the same spreadsheet app.

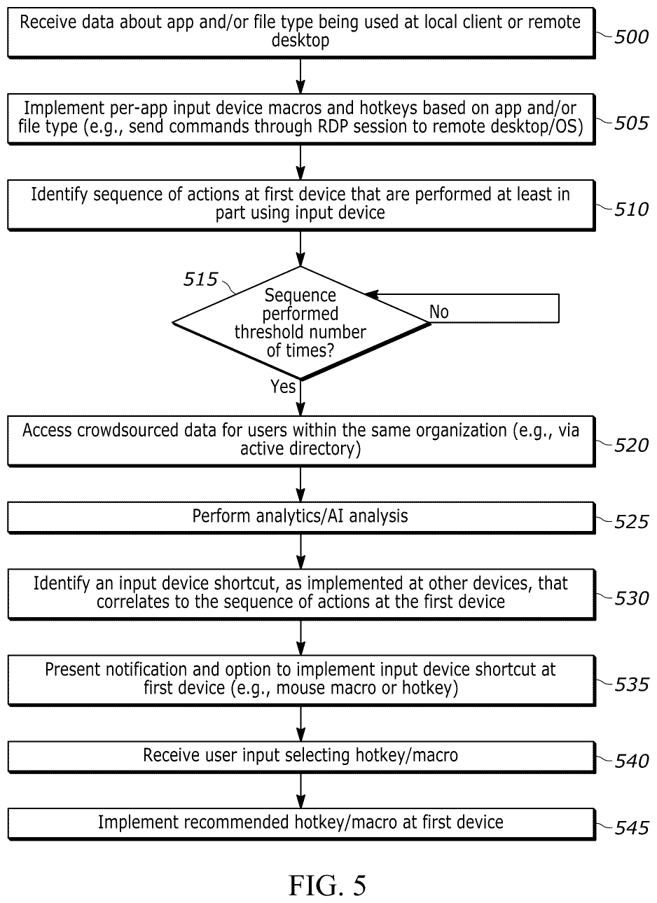

With the foregoing understanding in mind, reference is now made to FIG. 5. This figure shows example logic that may be executed by an apparatus that may include a client device and/or a coordinating server executing the logic of FIG. 5 alone or in any appropriate combination consistent with present principles. Thus, in some examples the logic may be executed by a client device alone. In other examples, some or all of the logic may be executed by a server hosting an enterprise-level active directory for different client devices connected to it over a network, where the active directory might track user inputs to individual client devices and then communicate with the local client device over the network to present notifications and options for implementing macros as discussed herein. Also note that while the logic of FIG. 5 is shown in flow chart format, other suitable logic may also be used.

Beginning at block 500, the apparatus may receive or otherwise access data about apps and file types that are currently being used at the local client device (“first device” for the description of FIG. 5) or remote desktop. The logic may then proceed to block 505 where the apparatus may, consistent with the disclosure above, implement one or more per-app (or per-file type or content type) input device macros and/or hotkeys based on whatever app, file type, or content is currently being presented in the active window of the first device (or remote desktop). Thus, at block 505 the apparatus may send commands received at the first device to the remote desktop or remote operating system through an active RDP session connecting the first device to the remote desktop.

From block 505 the logic may then proceed to block 510. Here the apparatus may, while the identified context is operative, identify a sequence of actions (or other inputs) at the first device that are performed using one or more input devices.

The logic of FIG. 5 may then proceed directly to subsequent steps in the logic or, in non-limiting examples, first proceed to decision diamond 515. Here, the apparatus may determine whether the sequence of actions has been performed at the first device at least a first threshold number of times greater than one within a threshold amount of time. A negative determination at diamond 515 may cause the logic to continue making the determination at diamond 515 until the first threshold is met in the present instance. Then once an affirmative determination is made, the logic may proceed to block 520 in response.

At block 520, the apparatus may access crowdsourced input device data for users within the same organization as the user of the first device. This might be done through an active directory for the organization that connects the client devices of its users. The logic may then proceed to block 525. Here the apparatus may execute one or more artificial intelligence (AI) models and/or data analytics algorithms to identify an input device shortcut that is already being used by others within the organization (e.g., at least another threshold number of times that is one or more orders of magnitude greater than the first threshold itself to reduce false positives and thus inapposite notifications from being presented to the user), and that also correlates to the relevant sequence of actions identified as being input to the first device while in the currently-operative context.

In terms of AI models specifically, note that one or more pattern recognition models may be used. For example, one or more convolutional neural networks may be used as pre-trained to recognize patterns in input device sequences based on context. Large language models (LLMs) and other generative pretrained transformers may also be used.

Accordingly, at block 530 the relevant input device shortcut may be identified as being implemented at least at a second device different from the first device (such as another client device of a coworker that works for the same organization as the user), with it being again noted that the shortcut correlates to the user's own sequence of actions at the first device. The shortcut may therefore perform the same function or sequence of inputs as the user themselves was performing using a series of individual inputs to the first device.

Then based on the identification of the input device shortcut, the logic may proceed to block 535. Here, the apparatus may present a notification at the first device regarding implementation of the input device shortcut at the first device. The apparatus may also present an option to implement the shortcut at the first device (such as the selector 420 described in the example above). Note that in non-limiting implementations where the first threshold above is being used, the notification and option(s) may be presented also based on the first threshold being met (but not before).

Thus, in one example the input device shortcut may include a mouse shortcut that applies a macro or hotkey for a button selection on the mouse. As another example, the input device shortcut may be a keyboard shortcut (macro or hotkey) assigned to an “F #” button at the top of the keyboard. A joystick input device might also have a certain button assigned for the macro or hotkey.

What's more, it is to be further understood consistent with present principles that an identified input sequence of the user might itself include a hotkey and macro. In such an instance, an additional hotkey or macro that is inclusive of the functions of the underlying hotkey/macro from the initial sequence, as well as the other inputs of the same sequence, may be recommended to the user. Thus, macros may be recommended to replace other macros, hotkeys may be recommended to replace other hotkeys, and macros may be swapped in and out with hotkeys in any appropriate combination to reduce the number of individual inputs the user would need to provide to the system using the input device in order to perform a given task.

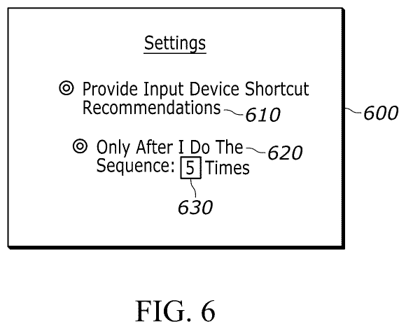

Continuing the detailed description in reference to FIG. 6, this figure shows an example GUI 600 that may be presented on a display for an end-user to configure one or more settings of an apparatus or software application (“app”) to operate consistent with present principles. Each option discussed below may be selected by selecting the respective radio button shown adjacent to that option, whether through cursor input, touch input, or another type of input.

As shown in FIG. 6, the GUI 600 may include an option 610 that is selectable to set or configure the apparatus/app to provide input device shortcut recommendations based on future identifications of input sequences performed by the user. Thus, selection of the option 610 may set or configure the apparatus/app to undertake the functions described above in reference to FIGS. 2-5.

In some examples, a sub-option 620 may also be selected to specifically set or configure the apparatus/app to present shortcut recommendations responsive to the user performing the relevant sequence a threshold number of times greater than one within a predefined amount of time (e.g., within two minutes). This too may help reduce false positives and hence unwanted recommendations. Accordingly, the GUI 600 may include a number entry box 630 at which the user may enter a number to assign to the threshold number of times. Though not shown, another number entry box may also be presented on the GUI to establish the predefined amount of time as well.

It may now be appreciated that present principles provide for an improved computer-based user interface that increases the functionality and ease of use of the devices disclosed herein. The disclosed concepts are rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principles have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. An apparatus, comprising:
a processor system; and
storage accessible to the processor system and comprising instructions executable by the processor system to:
identify a sequence of actions at a first device that are performed using an input device;
identify an input device shortcut, as implemented at a second device different from the first device, that correlates to the sequence of actions at the first device, the identified input device shortcut not implemented at the first device; and
based on the identification of the input device shortcut, present a notification at the first device regarding implementation of the input device shortcut at the first device.

2. The apparatus of claim 1, wherein the input device shortcut comprises a mouse shortcut.

3. The apparatus of claim 2, wherein the mouse shortcut applies a macro for a button selection on the mouse.

4. The apparatus of claim 2, wherein the mouse shortcut applies a hotkey for a button selection on the mouse.

5. The apparatus of claim 1, wherein the instructions are executable to:
determine that the sequence of actions has been performed at the first device at least a threshold number of times greater than one; and
based on the sequence of actions being performed at the first device at least the threshold number of times greater than one, present the notification at the first device.

6. The apparatus of claim 1, wherein the instructions are executable to:
based on the identification of the input device shortcut, present a selector on a display of the first device, the selector being selectable to set a first application (“app”) to issue commands consistent with the input device shortcut responsive to manipulations of a particular input element on the input device.

7. The apparatus of claim 6, wherein the first app is an input device app that is executable to interface between the input device and other apps executable at the first device.

8. The apparatus of claim 6, wherein the first app is an operating system of the first device.

9. The apparatus of claim 6, wherein the particular input element comprises one or more of: a button, a touch sensor, a pressure sensor, a wheel, a track ball.

10. The apparatus of claim 1, wherein the instructions are executable to:
identify the input device shortcut using analytics of data associated with an organization with which a first user of the first device and a second user of the second device are associated.

11. The apparatus of claim 10, wherein the data is crowdsourced data for the organization.

12. The apparatus of claim 1, comprising the first device.

13. The apparatus of claim 12, comprising the input device.

14. The apparatus of claim 1, comprising a server that communicates with the first device to present the notification.

15. A method, comprising:
identifying a sequence of actions at a first device that are performed using an input device;
identifying a shortcut, as implemented at a second device different from the first device, that correlates to the sequence of actions at the first device, the identified shortcut not implemented at the first device; and
based on the identification of the shortcut, presenting an option at the first device to implement the shortcut at the first device.

16. The method of claim 15, wherein the option is presented with a notification identifying the shortcut and indicating that the shortcut can be implemented at the first device.

17. The method of claim 16, wherein the notification also indicates an average amount of time that a user of the first device can save by using the shortcut.

18. The method of claim 17, wherein the average amount of time that the user can save is based on an average amount of time taken by the user to perform the sequence of actions at the first device without the shortcut.

19. An apparatus, comprising:
at least one computer readable storage medium (CRSM) that is not a transitory signal, the at least one CRSM comprising instructions executable by a processor system to:
identify sequence of inputs at a first device that are performed using an input device;
identify a shortcut, as implemented at other devices within a same organization as a user of the first device, that correlates to the sequence of inputs at the first device, the identified shortcut not already implemented at the first device; and
based on the identification of the shortcut, present an option at the first device to implement the shortcut at the first device.

20. The apparatus of claim 19, wherein the instructions are executable to:
use an active directory to identify the shortcut as implemented at the other devices within the same organization.
